(19) United States
(12) Patent Application Publication
(10) Pub. No.: US 2010/0039944 A1
(43) Pub. Date: Feb. 18, 2010

(54) Distributed system

(76) Inventors: Masahiro Matsubara, Tokai (JP); Kohei Sakurai, Hitachi (JP); Kotaro Shimamura, Hitachinaka (JP)

Correspondence Address: Juan Carlos A. Marquez;c/o Stites & Harbison PLLC, 1199 North Fairfax Street, Suite 900, Alexandria, VA, 22314-1437, US

(21) Appl. No.: 12/457,329

(22) Filed: Jun. 8, 2009

(30) Foreign Application Priority Data
Jun. 27, 2008 (JP) 2008-168052

(51) Int. Cl. H04L 12/26

(52) U.S. Cl. 370/242

(57) ABSTRACT

A distributed system performs fault identification using inter-node monitoring so as to locate a fault with high reliability and ensure consistent recognition about the situation of the fault occurrence among nodes. The process is synchronized with a communication cycle. If a system does not need to perform the fault identification as often as every communication cycle, the frequency of the fault identification should be decreased so as to reduce a load for CPU processing and a consumption of a communication band per unit time.

A distributed system of the present invention includes plural nodes that are connected to each other via a network. Each of the nodes includes a fault-monitoring section, a transmission and reception section, and a fault-identification section. The fault-monitoring section monitors a fault in other nodes. The transmission and reception section transmits and receives data to detect the fault in other nodes via the network. The fault-identification section identifies which node has the fault based on the data. The fault-monitoring section uses one or more communication cycles as a monitoring period; the communication cycles are synchronized between the nodes.

### CLAIM OF PRIORITY

The present application claims priority from Japanese Patent Application JP 2008-168052 filed on Jun. 27, 2008, the content of which is hereby incorporated by reference into this application.

### FIELD OF THE INVENTION

The present invention relates to a distributed system for exercising highly reliable control based on cooperative operations of multiple networked devices.

### BACKGROUND OF THE INVENTION

In order to improve driving comfort and safety of vehicles, vehicle control systems are being developed that reflect, using electronic control rather than mechanical coupling, driver's operations on an accelerator, a steering wheel, a brake, and the like in vehicle mechanisms for generating driving, steering, and braking forces. Similar electronic control is presently applied to other devices such as construction equipment. In these systems, multiple electronic control units (ECUs) are distributed on the devices and provide cooperative operations by exchanging data via a network. When a fault occurs in an ECU in a network, it is required, for a fail-safe, that each of the other ECUs within the same network accurately locates the fault and provides backup control appropriate to the content of the fault. Japanese Published Unexamined Patent Application No. 2000-47894 discloses a technology allowing each of nodes (e.g., ECUs as processors) included in the system to monitor the other networked nodes.

The technology described in Japanese Published Unexamined Patent Application No. 2000-47894 requires a special node (shared disk) to share monitoring information about operating states of database applications and the like with respective nodes. A fault of the shared disk inhibits continuous monitoring of nodes in the system. Installation of the shared disk may increase system costs.

The following method may solve the problem. Each of the nodes independently monitors a specific item of a given node so as to detect a fault. The nodes exchange a fault-monitoring result through the network. A fault is finally located from the fault-monitoring results collected in the nodes by a majority rule, for example. These processes are synchronized with a communication cycle. The above-mentioned processes of monitoring a fault, exchanging the fault-monitoring results, and locating the fault are performed in a pipelined fashion, making it possible to locate the fault at every communication cycle.

However, locating a fault at every communication cycle may be too frequent for a system. An object of the present invention is to provide a distributed system that can configure cycles for fault monitoring and communication independently to reduce processing loads on a central processing unit (CPU) and communication bands for fault monitoring and increase the degree of freedom for configuring fault-monitoring cycles.

### SUMMARY OF THE INVENTION

To achieve the above-mentioned object, an aspect of the present invention provides a distributed system that includes plural nodes being connected to each other via a network. Each of the nodes includes a fault-monitoring section for monitoring a fault in other nodes; a transmission and reception section for transmitting and receiving data to detect the fault in other nodes via the network; and a fault-identification section for identifying which node has the fault based on the data. The fault-monitoring section uses plural communication cycles as a monitoring period; the plural communication cycles are synchronized between the nodes.

The distributed system of the present invention may include the transmission and reception section that includes a monitoring result from the fault-monitoring section in transmission and reception data and distributes transmission and reception of the data into a next monitoring period. The next monitoring period is a next period of when the monitoring result is obtained.

The distributed system of the present invention may include the fault-identification section that distributes fault identification into next monitoring period. The next monitoring period is a next period of when the monitoring result is obtained by the fault-monitoring section. The monitoring result is included in the data.

The distributed system of the present invention may include the fault-monitoring section that changes, while the distributed system is in operation, the monitoring period for each node to be monitored.

The present invention can provide a distributed system that reduces processing loads on a central processing unit (CPU) and communication bands for fault monitoring and increases the degree of freedom for configuring fault-monitoring cycles.

### BRIEF DESCRIPTION OF THE DRAWINGS

FIG. 1 is a block diagram of a distributed system;

FIG. 2 is a flow chart showing a fault-identification process based on inter-node monitoring;

FIG. 3 shows an example of the fault-identification process in a pipelined fashion;

FIG. 4 shows another example of the fault-identification process in a pipelined fashion;

FIG. 5 shows an operation example of the fault-identification process;

FIG. 6 is a flow chart showing the fault-identification process distributed among nodes;

FIG. 7 shows an example of the fault-identification process distributed among nodes in a pipelined fashion;

FIG. 8 shows another example of the fault-identification process distributed among nodes in a pipelined fashion;

FIG. 9A shows an operation example of the fault-identification process;

FIG. 9B shows another operation example of the fault-identification process;

FIG. 10 shows an example of the fault-identification process capable of varying an active cycle in a pipelined fashion;

FIG. 11 shows another example of the fault-identification process capable of varying an active cycle in a pipelined fashion;

FIG. 12A shows an operation example of the fault-identification process capable of varying an active cycle; and

FIG. 12B shows another operation example of the fault-identification process capable of varying an active cycle.

### DETAILED DESCRIPTION OF THE PREFERRED EMBODIMENTS

Embodiments of the present invention will be described in detail with reference to the drawings.

### First Embodiment

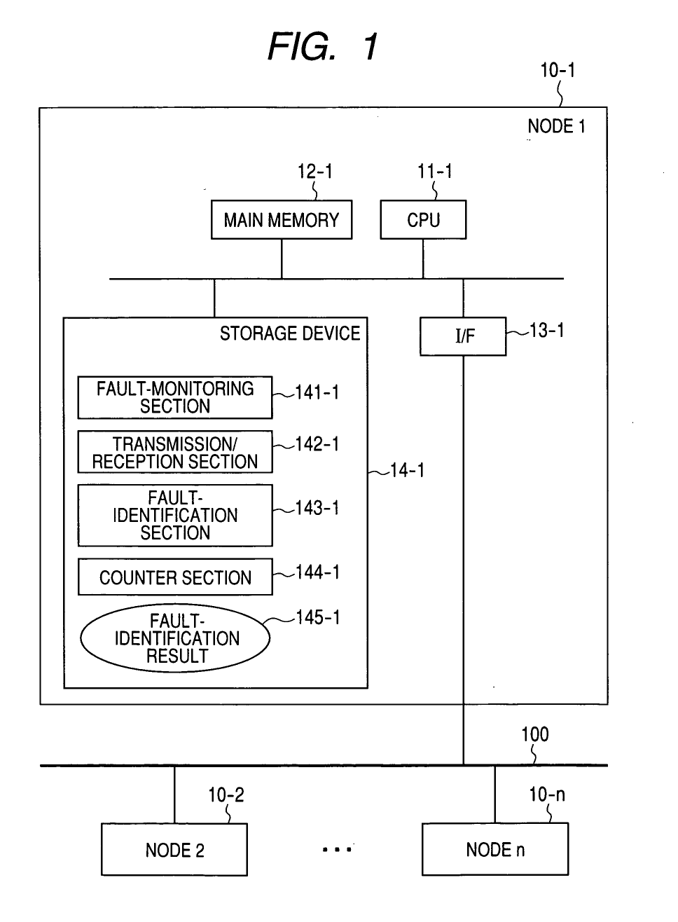

FIG. 1 is a block diagram of a distributed system.

The distributed system includes multiple nodes 10, such as 10-1, 10-2, . . . , and 10-n. The nodes are connected via a network 100. The nodes are equivalent to a processor capable of information communication via the network, including various electronic control devices such as the CPU, actuators, and necessary drivers, and sensors. The network 100 is capable of multiplex communication and broadcast transmission that simultaneously transmits the same content from a given node to all the other nodes connected to the network. The distributed system may use a communication protocol such as FlexRay (registered trademark of Daimler AG) and TTCAN (time-triggered CAN).

Each node is represented by i, where i is the node number ranging from 1 to n. Each node includes a CPU 11-i, a main memory 12-i, an interface (I/F) 13-i, and a storage device 14-i. The nodes are connected to each other through an internal communication line or the like. The interface 13-i is connected to the network 100.

The storage device 14-i includes programs, such as a fault-monitoring section 141-i, a transmission/reception section 142-i, a fault-identification section 143-i, and a counter section 144-i, and a fault-identification result 145-i. The fault-identification result 145-i includes a monitoring result table, a fault-identification result table, and an error counter, which are described later.

The CPU 11-i reads these programs into the main memory 12-i and executes the programs for processes. The programs or data described in this specification may be stored in the storage device in advance, may be supplied from storage media such as CD-ROM, or may be downloaded from other devices via the network. Special hardware may be used to realize functions implemented by the programs.

In the following explanation, the programs are described as an agent of the processing but the actual agent is the CPU, which performs processing according to the programs.

The fault-monitoring section 141-i performs fault monitoring (MON) on the other nodes. The transmission/reception section 142-i transmits or receives data via the network 100 for detecting faults on the other nodes. The fault-identification section 143-i performs fault identification (ID) to identify which node has a fault based on data for detecting faults on the other nodes. The counter section 144-i counts the number of errors in a node identified as having a fault, with respect to nodes, error locations (error items), and fault-identification conditions to be described later.

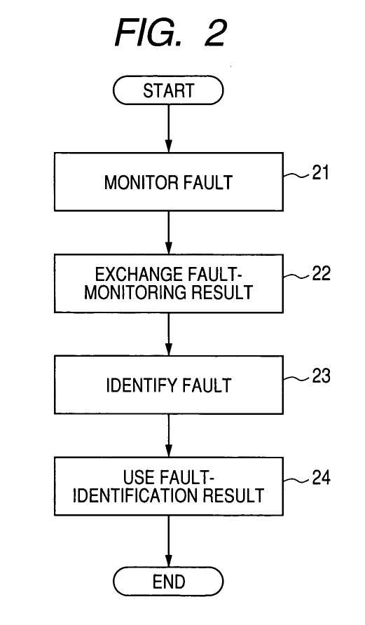

FIG. 2 is a flow chart showing a fault-identification process based on inter-node monitoring. The process is performed by mutual synchronous communication of each node through the network 100.

At Step 21, the fault-monitoring section 141-i monitors a fault on the other nodes, performing a fault-monitoring process (MON) that determines, by node i itself, whether a fault occurs or not in a transmission node according to the contents of received data or the situation of reception. It may be preferable to use multiple fault-monitoring items. For example, an item “reception malfunction” indicates a malfunction when the data reception has an error, such as detection of unsuccessful reception or a malfunction in received data based on an error-detecting code. An item “sequence number malfunction” is used as follows. The transmission node supplies transmission/reception data with a sequence number that an application increments at every communication cycle. The reception node checks an increment of the sequence number and detects a malfunction when the sequence number is not incremented. The sequence number is used to confirm an application malfunction in the transmission node. An item “self-diagnosis malfunction” is used as follows. Each of the nodes performs self-diagnosis as to whether the node itself has a malfunction or not and transmits a result of the diagnosis (self-diagnosis result) to the other nodes. The reception node detects a malfunction in the transmission node by using the self-diagnosis result. When any of the fault-monitoring items indicates a malfunction, a fault-monitoring item that unifies the other fault-monitoring items may be used to notify “malfunction detected.”

The fault-monitoring process is performed at p-communication cycle, where p denotes 1, 2, 3, . . . . The p-communication cycle is used as a unit of the period. The nodes are synchronized with each other during a fault-monitoring period at the p-communication cycle. To activate the synchronization, a node may declare initiation of the fault-monitoring process using the communication. Alternatively, the number of communication cycles may be used to determine the monitoring period. For example, if the first fault monitoring is defined to begin with communication cycle 0, the beginning of each fault-monitoring period can be found from no residual in the calculation of dividing the number of communication cycles by p. The use of multiple communication cycles for the period of the fault-monitoring process can decrease the frequency of subsequent processes and reduce a communication band per communication cycle and a processing load on the CPU in each node.

At Step 22, the transmission/reception section 142-i performs a fault-monitoring result exchange process (EXD) that exchanges the fault-monitoring result acquired at Step 21 among the nodes. Each node holds the fault-monitoring results from all the nodes including the result of the node itself. The collected fault-monitoring results are stored in the monitoring result table of the fault-identification result 145-i.

The fault-monitoring result exchange process may be performed at one communication cycle or divided into multiple communication cycles. Performing the fault-monitoring result exchange process over multiple communication cycles reduces a necessary communication band per communication cycle and a load for processing received data on the CPU of each node.

At Step 23, the fault-identification section 143-i performs a fault-identification process (ID) that determines whether each node and each fault-monitoring item has a malfunction or not from the fault-monitoring results collected in the nodes at Step 22. A fault-identification result is stored in the fault-identification result table of the fault-identification result 145-i.

One of the fault-identification methods is a majority rule, which decides whether a malfunction is occurred or not by the number of nodes. If the number of nodes having detected a fault in a given node or fault-monitoring item is greater than or equal to a threshold value of a fault-identification condition 1, the node subject to the fault detection is assumed to be abnormal. If the number of the nodes is smaller than a threshold value of a fault-identification condition 2, the node having detected the fault is assume to be abnormal. Normally, the threshold value is equivalent to half the number of the collected fault-monitoring results.

A node is assumed to be normal if it detects no fault under the fault-identification condition 1 or it is a node subject to the fault detection under the fault-identification condition 2. In the following description, a fault satisfying the fault-identification condition 1 is referred to as a majority malfunction. A fault satisfying the fault-identification condition 2 is referred to as a minority malfunction.

There is another fault-identification method, which assumes a node subject to fault detection or a fault-monitoring item to be abnormal if at least one node detects a fault.

The fault-identification process may be performed at one communication cycle or divided into multiple communication cycles. Performing the fault-monitoring result exchange process over multiple communication cycles can reduce a load for CPU processing per communication cycle in each node.

At Step 24, each node performs a fault-identification result utilization process. If a malfunction is determined at Step 23, the counter section 144-i increments an error counter value that indicates the number of errors in the node or the monitoring item subject to the fault identification. If no malfunction is determined, the counter section 144-i decrements the counter value. The counter section 144-i may reset the counter value or do nothing instead of decrementing. Setting whether to decrement, to reset, or to do nothing is selected in advance. The error counter may be provided for each of the fault-identification conditions. In this case, the error counter is decremented or reset if none of the fault-identification conditions is satisfied.

If the number of errors reaches the specified threshold value or more, the counter section 144-i notifies a control application of a fault occurrence. One of the notification means is to turn on a node fault flag corresponding to the node or the monitoring item subject to the fault identification. The application, referring to the node fault flag, can identify the fault occurrence. The fault occurrence may be immediately notified by interrupting the control application or invoking a callback function after the node fault flag is turned on. When the error counter is provided for each of the fault-identification conditions, the node fault flag is also provided for each of the fault-identification conditions.

When the fault-identification process is divided into multiple communication cycles, the fault-identification result utilization process may be performed when all the fault-identification processes are completed or when part of the fault-identification processes is completed to make sequential use of the results of the part of the fault-identification processes. The former should be employed if all nodes need to maintain the same recognition on the fault occurrence or the same state transition according to the fault occurrence.

The above-mentioned processes can locate the fault occurrence with high reliability and provide the nodes with the same recognition on the error occurrence. In this case, distributing the processes into multiple communication cycles can reduce a load for CPU processing or suppress necessary communication bands per communication cycle.

The processes in FIG. 2 may be performed in parallel when the processes are performed repeatedly. Defining an opportunity to perform the process in FIG. 2 once as a fault-identification round, it may be preferable to perform the multiple fault-identification rounds in parallel.

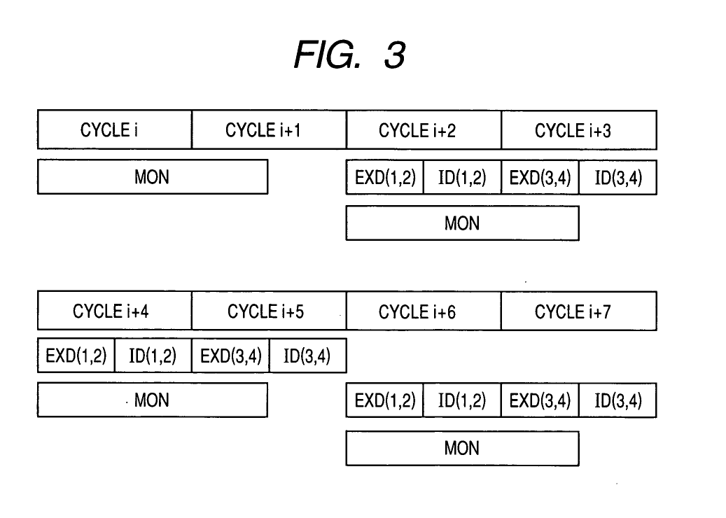

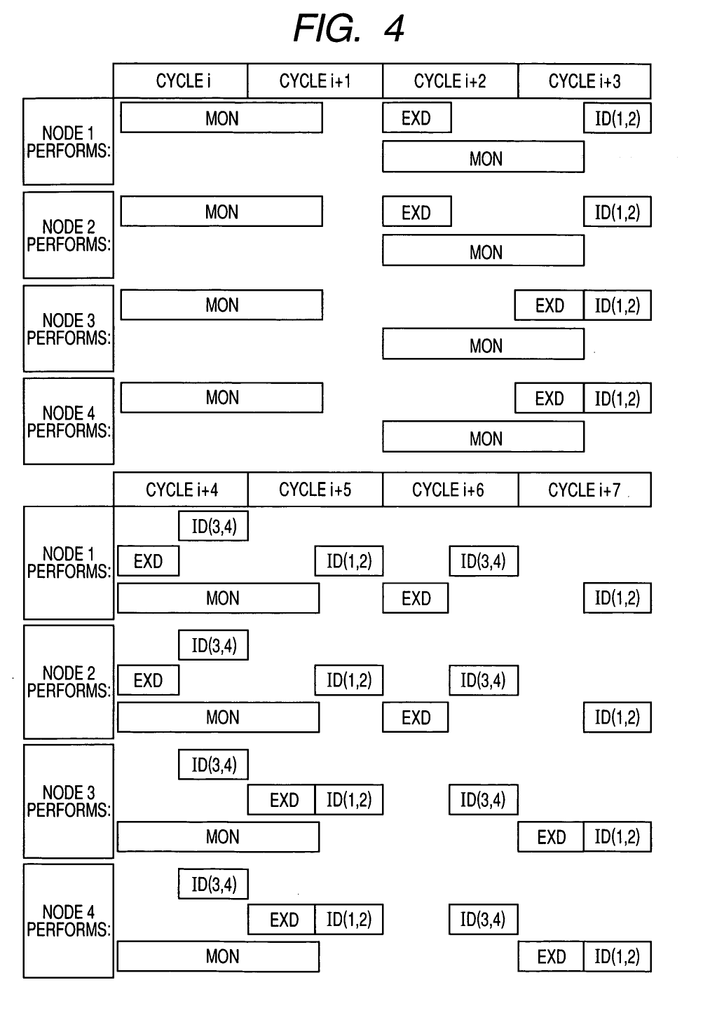

FIGS. 3 and 4 show examples of parallel processing of identifying a fault in a 4-node system by the inter-node monitoring based on the process flow in FIG. 2.

In FIG. 3, as a fault-identification round 1, the fault monitoring (MON) is performed at communication cycles i and i+1 (r=2), the fault-monitoring result exchange (EXD) and the fault identification (ID) being distributed into communication cycles i+2 and i+3. Each node exchanges the monitoring results (EXD) for nodes 1 and 2 at the communication cycle i+2 and nodes 3 and 4 at the communication cycle i+3, performing the fault identification (ID) from the monitoring results. As shown in FIG. 3, the fault-monitoring result exchange process (EXD) and the fault-identification process (ID) are divided into the nodes and are distributed into the communication cycles.

The nodes concurrently perform the fault-identification round 1 and a fault-identification round 2 and later. At the communication cycles i+2 and i+3, the fault-monitoring result exchange (EXD) is performed for the fault-identification round 1. At the same time, the fault monitoring (MON) is performed for the fault-identification round 2 according to the content of the received data or the situation of the data reception resulting from the fault-monitoring result exchange (EXD). Similarly, the fault monitoring (MON) is performed for a fault-identification round 3 simultaneously with the fault-monitoring result exchange (EXD) for the fault-identification round 2. The fault identification (ID) is performed between whiles. These processes are repeated subsequently. Results of the fault identification (ID) may be used from the nodes 1 and 2 first or from all the nodes after acquisition of results from the nodes 3 and 4.

In FIG. 4, as the fault-identification round 1, the fault monitoring (MON) is performed at the communication cycles i and i+1, the fault-monitoring result exchange (EXD) being distributed into the communication cycles i+2 and i+3 and the fault identification (ID) being distributed into the communication cycles i+3 and i+4. The results of the fault monitoring (MON) are transmitted from the nodes 1 and 2 at the communication cycle i+2 and from the nodes 3 and 4 at the communication cycle i+3. The fault identification (ID) is performed on the nodes 1 and 2 at the communication cycle i+3 and on the nodes 3 and 4 at the communication cycle i+4. A difference from FIG. 3 is to divide the fault-monitoring result exchange (EXD) process into the transmission nodes and distribute the process into the communication cycles.

The nodes concurrently perform the fault-identification round 1 and the fault-identification round 2 and later. At the communication cycles i+2 and i+3, the fault-monitoring result exchange (EXD) is performed for the fault-identification round 1. At the same time, the fault monitoring (MON) is performed for the fault-identification round 2 according to the content of the received data or the situation of the data reception resulting from the fault-monitoring result exchange (EXD). Relation between the fault-identification rounds 2 and 3 is the same and the above-mentioned processes are repeated subsequently.

As shown in FIGS. 3 and 4, the fault-identification process according to the inter-node monitoring in FIG. 2 is performed in a pipelined fashion. In this manner, the fault monitoring (MON) is applicable to all the time intervals (communication cycles). In addition, the fault identification (ID) can be continuously performed at a specified interval.

While FIGS. 3 and 4 assume the number of nodes to be four (n=4), the number of nodes is not limited. In FIGS. 3 and 4, two communication cycles are used as an applicable period for the fault monitoring (MON), and the fault-monitoring result exchange (EXD) process and the fault-identification (ID) process are distributed into the two communication cycles. The number of communication cycles may be one or more than two. Decreasing the number of communication cycles for each process shortens the time (the number of communication cycles) needed for the fault identification (ID) but relatively increases a load for CPU processing or a communication band to be consumed. Increasing the number of communication cycles for each process lengthens the time (the number of communication cycles) needed for the fault identification (ID) but relatively decreases a load for CPU processing or a communication band to be consumed.

For example, in a case of six nodes in FIG. 3, the fault-monitoring result exchange (EXD) and the fault identification (ID) may be performed on the nodes 1 to 3 at the communication cycle i+2 and on the nodes 4 to 6 at the communication cycle i+3 for the first fault-identification round. Alternatively, it may be preferable to add the fault-monitoring result exchange (EXD) and the fault identification (ID) to be performed on nodes 5 and 6 at a communication cycle i+4.

Distribution of the fault-monitoring result exchange (EXD) and the fault identification (ID) to communication cycles is hereafter referred to as time-base process distribution. The time-base process distribution is preferable when a load for CPU processing and a quantity of communication are equal for each communication cycle. This is because the control application is relatively less affected by resources such as the CPU throughput and the communication band. FIGS. 3 and 4 show the examples of such equal distribution.

As for the time-base process distribution, the processes are distributed into the nodes for fault monitoring, the nodes for fault identification, and the nodes for transmission in FIGS. 3 and 4. However, the processes may be distributed in any manner as long as each node performs a part of the process at each communication cycle. In FIG. 4, for example, each node may perform a part of the fault-identification (ID) process, such as counting for a majority rule, at the communication cycle i+2 using fault-monitoring results received from the nodes 1 and 2 and then perform the rest of the fault-identification (ID) process at the communication cycle i+3 using fault-monitoring results received from the nodes 3 and 4 to complete the fault-identification process. This decreases by one the number of communication cycles in FIG. 4 needed to complete the fault-identification process.

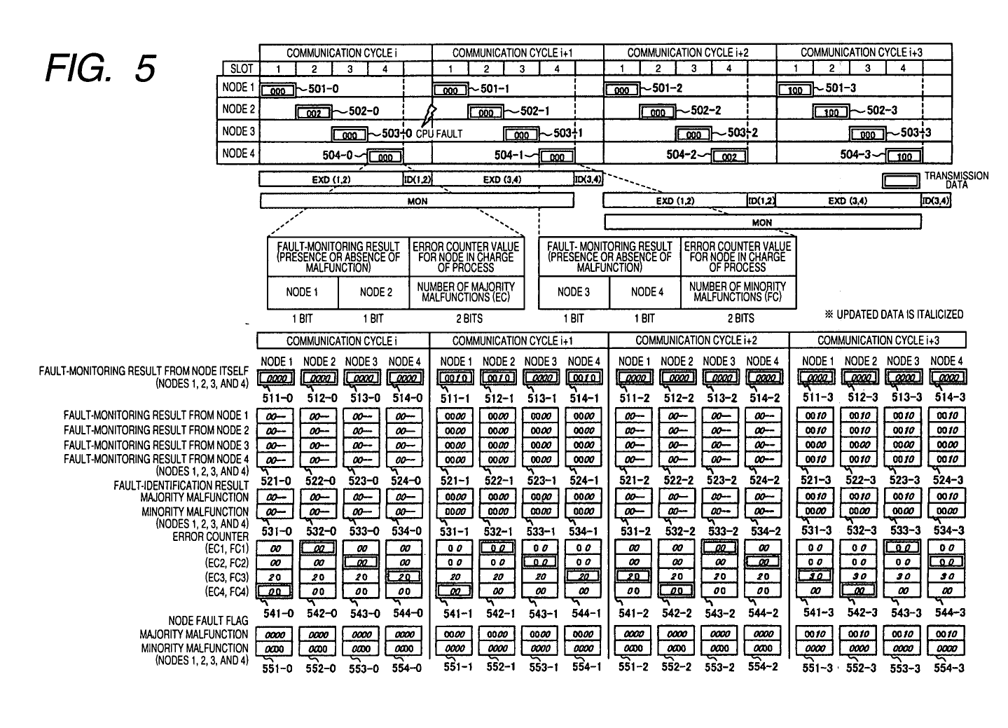

FIG. 5 shows an operation example of the fault-identification process based on the inter-node monitoring. The process flow is based on FIG. 2. The time-base process distribution and the process pipelining are compliant with FIG. 3. The number of nodes is assumed to be four. In this example, various items are unified as one fault-monitoring item. The fault-identification process (ID) is performed at the end of the communication cycles after termination of transmission or reception of each node.

Transmission data includes bits for two nodes, each of the bits indicating the presence or absence of a malfunction concerning a node to be monitored. An area corresponding to a given node stores a result of diagnosis about the given node. The presence or absence of a malfunction concerning the nodes 1 and 2 are stored at an even-numbered cycle. The presence or absence of a malfunction concerning the nodes 3 and 4 are stored at an odd-numbered cycle.

The transmission data also includes an error counter value, which each node has, of one node. At the communication cycles i and i+1, the node 1 transmits an error counter value for the node 2; the node 2 transmits an error counter value for the node 3; the node 3 transmits an error counter value for the node 4; the node 4 transmits an error counter value for the node 1. At the communication cycles i+2 and i+3, the node 1 transmits an error counter value for the node 4; the node 2 transmits an error counter value for the node 1; the node 3 transmits an error counter value for the node 2; the node 4 transmits an error counter value for the node 2. The nodes are rotated. Error counters are independent for a majority malfunction and a minority malfunction. The number of majority malfunctions (EC) is transmitted at an even-numbered cycle. The number of minority malfunctions (FC) is transmitted at an odd-numbered cycle.

When receiving an error counter value, the node uses the received error counter value to synchronize the error counters between nodes in the fault-identification result utilization process before the node reflects the result of the fault identification (ID) on the error counter. This is because the error counter values may differ from node to node even when the fault-identification process is performed in accordance with the inter-node monitoring. Possible causes of this difference include a reset based on diagnosis on the node itself or temporal communication failure. The error counters may be synchronized as follows. If a node receives a counter value that differs from the counter value that the node has and a difference of successively received two counter values is within a given value (e.g., ±1), the counter value for the node is adjusted to the later received counter value.

The transmission data indicates only part of the contents. The transmission data may include a sequence number and control data as well as the above-mentioned data.

At communication cycle i, where i is an even number, the nodes 1 to 4 sequentially use slots 1 to 4 to transmit fault-monitoring results (EXD, 501-0 to 504-0) concerning the nodes 1 and 2 for a fault-identification round k−1, maintaining results received from the other nodes and generated from the node itself (521-0 to 524-0 represented in binary). Since the results include no data indicating “abnormality” and are normally received by the nodes, no malfunction is found in the fault identification (ID) concerning the nodes 1 and 2 for the fault-identification round k−1 and none of the nodes turns on the node fault flag (551-0 to 554-0 represented in binary). None of the nodes detects a fault during the fault monitoring (MON) for a fault-identification round k (511-0 to 514-0 represented in binary). The error counter value for each node indicates 2 corresponding to the majority malfunction of the node 3 and indicates 0 otherwise. No change is made from a communication cycle i−1 (541-0 to 544-0).

However, the node 3 causes a CPU fault at the end of the communication cycle i. It is assumed that this fault leads to a fault that disables the node 3 from incrementing a sequence number to be transmitted at the next communication cycle i+1. The sequence numbers are not shown in the data in FIG. 5.

At the communication cycle i+1, the nodes transmit fault-monitoring results (501-1 to 504-1) concerning the nodes 3 and 4 for the fault-identification round k−1 and maintain the results (521-1 to 524-1). Similarly to the communication cycle i, no malfunction is found in the fault identification (ID) concerning the nodes 3 and 4 for the fault-identification round k−1 and the error counter (541-0 to 544-0) and the node fault flag (551-1 to 554-1) are the same as those for the communication cycle i. However, the nodes 1, 2, and 4 detect a fault in the node 3 (511-1, 512-1, and 514-1) according to sequence number malfunctions of the node 3 during the fault monitoring (MON) concerning the nodes 3 and 4 for the fault-identification round k. The node 3 cannot detect a malfunction in the node 3 itself (513-1).

The fault-identification result exchange (EXD) and the fault identification (ID) for the fault-identification round k and the fault monitoring (MON) for the fault-identification round k+1 are performed on the nodes 1 and 2 at the communication cycle i+2 and on the nodes 3 and 4 at the communication cycle i+3. No malfunction is detected at a communication i+2 similarly to the communication cycle i. At the communication cycle i+3, the fault-monitoring result exchange (EXD) for the fault-identification round k exchanges fault detection results of the node 3 at the communication cycle i+i (501-3 to 504-3 and 521-3 to 524-3) and the fault identification (ID) for each node identifies a majority malfunction of the node 3 (531-3 to 534-3). As a result, the error counter value of each node concerning the majority malfunction of the node 3 is incremented to 3 (541-3 to 544-3). The threshold value in the system is 3 for the application to notify a fault; therefore the node fault flag of each node concerning the majority malfunction of the node 3 is turned on (551-3 to 554-3).

As mentioned above, the CPU fault of the node 3 is identified by each node and the corresponding node fault flag notifies the application of the fault. The fault-identification process according to the inter-node monitoring in FIG. 2 can be performed in a pipelined fashion in synchronization with the communication cycle. The time-base process distribution reduces the load for the CPU processing and the quantity of the communication per communication cycle compared to a case without the time-base process distribution. The minority malfunction is processed in the same way as the above example, which describes the majority malfunction.

### Second Embodiment

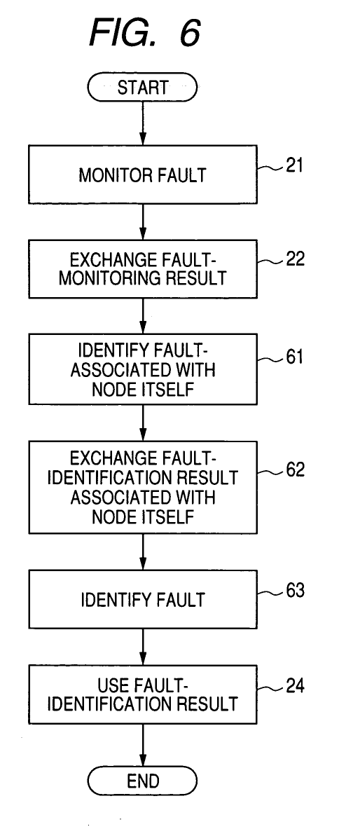

FIG. 6 is a flow chart of the fault-identification process according to the inter-node monitoring.

The fault monitoring (MON) at Step 21 and the fault-monitoring result exchange process (EXD1 in FIG. 6) at Step 22 are the same as those in FIG. 2.

At Step 61, the fault-identification section 142-i performs the fault-identification process (ID1) on one node of nodes involved in mutual monitoring except the node itself. The node itself is responsible for the one node about the fault identification. The relevant nodes rotate for every communication cycle so as not to conflict with each other. In this manner, a load on the fault-identification process is distributed among the nodes and reduced.

At Step 62, the transmission/reception section 142-i performs a fault-identification result exchange process (EXD2) that exchanges a fault-identification result about the one node acquired at Step 61 among the nodes. Consequently, each node maintains fault-identification results about all the nodes including the result processed by the node itself. At Step 63, a fault-identification process (ID2) uses the collected fault-identification results to settle a final fault-identification result.

Step 24 is the same as that of the fault-identification result utilization process in FIG. 2.

The fault-identification process (ID1) may use the fault-identification condition 1 for determination about one node. The fault-identification process (ID2) may use the fault-identification condition 2 for determination about all nodes. Alternatively, the fault-identification process (ID2) may use the fault-identification condition 2 for determination about one node. This result may be exchanged among the nodes using a fault-identification result exchange process (EXD3).

The fault-identification process (ID1) may be performed on two or more nodes, not limited to one node.

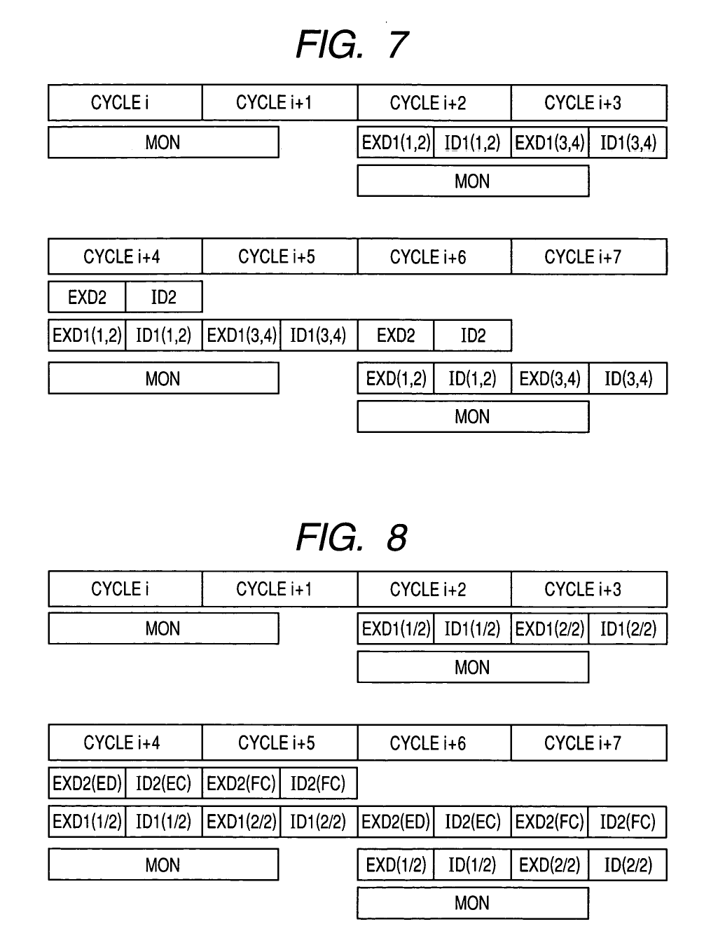

FIGS. 7 and 8 show examples of parallel processing for identifying a fault in a 4-node system using the inter-node monitoring based on the process flow in FIG. 6.

In FIG. 7, as the fault-identification round 1, the fault monitoring (MON) is performed at the communication cycles i and i+1. The fault-monitoring result exchange (EXD1) and the fault identification (ID1) are distributed into the communication cycles i+2 and i+3. The fault-identification result exchange (EXD2) and the fault identification (ID2) are distributed into the communication cycles i+4 and i+5. The nodes perform the fault-monitoring result exchange (EXD1) and the fault identification (ID1) on the nodes 1 and 2 at the communication cycle i+2 and on the nodes 3 and 4 at the communication cycle i+3. The nodes perform the fault-identification result exchange (EXD2) and the fault identification (ID2) on all the nodes at the communication cycle i+4. As shown in FIG. 7, the fault-monitoring result exchange process (EXD1) and the fault-identification process (ID1) are divided into the nodes and are distributed into the communication cycles.

The nodes concurrently perform the fault-identification round 1 and the fault-identification round 2 and later. At the communication cycles i+2 and i+3, the fault-monitoring result exchange (EXD1) is performed for the fault-identification round 1. At the same time, the fault monitoring (MON) is performed for the fault-identification round 2 according to the content of the received data or the situation of the data reception. At the communication cycle i+4, the fault-identification result exchange (EXD2) is performed for the fault-identification round 1. At the same time, the fault-monitoring result exchange (EXD1) is performed on the nodes 1 and 2 for the fault-identification round 2. The fault monitoring (MON) is performed for the fault-identification round 3 according to the content of the received data or the situation of the data reception. Relation between the fault-identification rounds 2 and later is the same and the above-mentioned processes are repeated subsequently.

In FIG. 8, as the fault-identification round 1, the fault monitoring (MON) is performed at the communication cycles i and i+1. The fault-monitoring result exchange (EXD1) and the fault identification (ID1) are distributed into the communication cycles i+2 and i+3. The fault-identification result exchange (EXD2) and the fault identification (ID2) are distributed into the communication cycles i+4 and i+5. The nodes perform a half of the processes of fault-monitoring result exchange (EXD1) and fault identification (ID1) at the communication cycles i+2 and i+3, respectively. The half means that the fault-monitoring result exchange (EXD1) transmits a half of the fault-monitoring result at the communication cycle i+2; the fault identification (ID1) halfway performs the process of collecting fault-monitoring results for the fault identification, such as a majority rule, just for the data acquired by the fault-monitoring result exchange (EXD1).

The remaining process is performed at the communication cycle i+3. The nodes perform the fault-identification result exchange (EXD2) and the fault identification (ID2) concerning a majority malfunction at the communication cycle i+4 and a minority malfunction at the communication cycle i+5. As shown in FIG. 7, the processes of fault-monitoring result exchange (EXD1), fault-identification result exchange (EXD2), and fault identifications (ID1 and ID2) are distributed into the communication cycles.

The nodes concurrently perform the fault-identification round 1 and the fault-identification round 2 and later. At the communication cycles i+2 and i+3, the fault-monitoring result exchange (EXD1) is performed for the fault-identification round 1. At the same time, the fault monitoring (MON) is performed for the fault-identification round 2. At the communication cycles i+4 and i+5, the fault-identification result exchange (EXD2) is performed for the fault-identification round 1. At the same time, the fault-monitoring result exchange (EXD1) is performed for the fault-identification round 2. The fault monitoring (MON) is performed for the fault-identification round 3 as well. Relation between the fault-identification rounds 2 and later is the same and the above-mentioned processes are repeated subsequently.

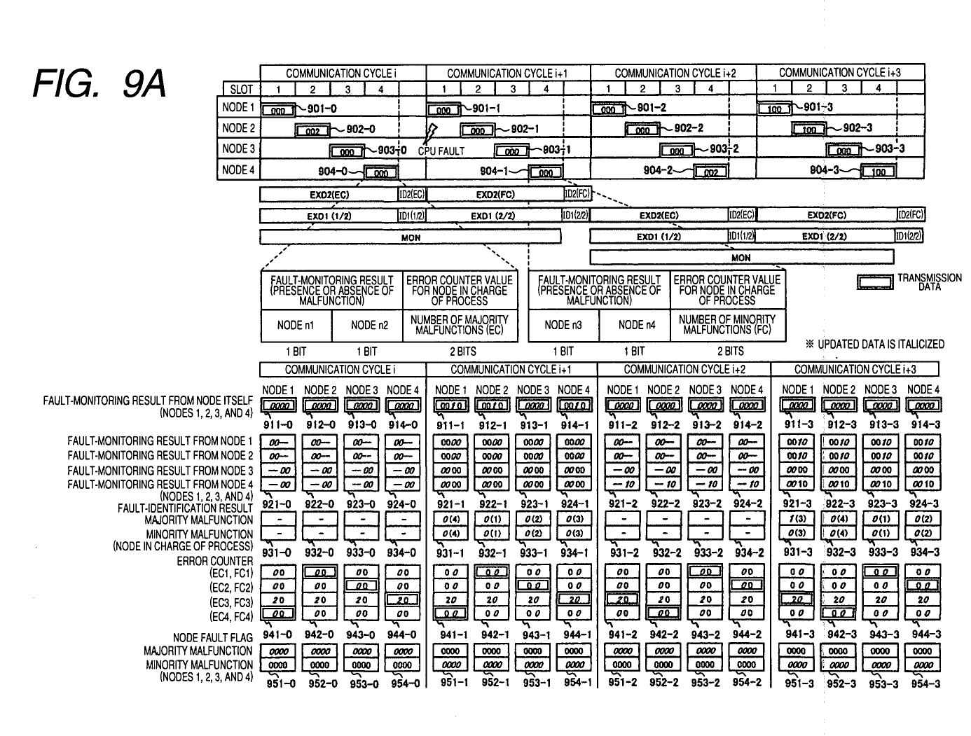

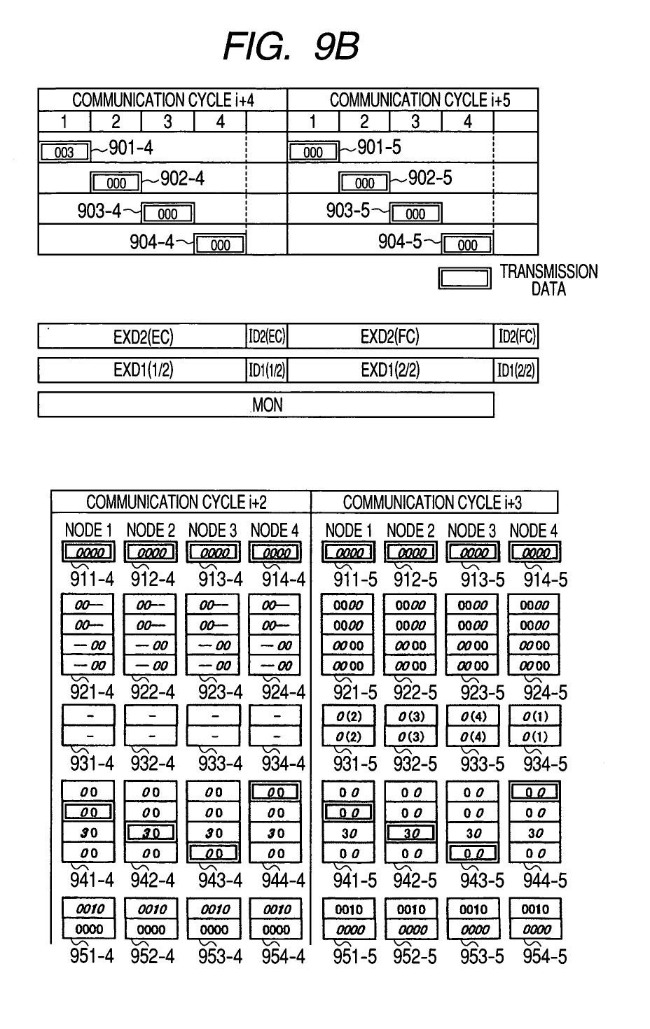

FIGS. 9A and 9B show operation examples of the fault-identification process according to the inter-node monitoring. The process flow is based on FIG. 6. The time-base process distribution and the process pipelining are compliant with FIG. 8. The conditions, such as the number of nodes and the fault-monitoring items, are the same as those shown in FIG. 5.

A result of the fault identification (ID1) is reflected on the error counter value. The fault-identification result exchange (EXD2) includes increase or decrease of the error counter value in accordance with the result of the fault identification (ID1), transmission of the error counter value, and transmission of the counter value for error counter synchronization. When receiving the error counter value, the node synchronizes the error counter. An example of the method for synchronizing is as follows. (1) If a difference between the received counter value and the counter value of the node itself is a specified value (e.g., ±1), the node itself adjusts the counter value to the received counter value. (2) If the condition (1) is not satisfied and a difference between successively received two counter values is a specified value (e.g., ±1), the node itself adjusts the counter value to the later received counter value.

The transmission data may include an area exclusively used for results of the fault identification (ID1) without reflecting the result of the fault identification (ID1) on the error counter value.

At the communication cycles i and i+1, where i is an even number, the nodes 1 to 4 sequentially use slots 1 to 4 to transmit fault-monitoring results (EXD1, 901-0 to 904-0 and 901-1 to 904-1) for the fault-identification round k−1, maintaining results received from the other nodes and generated from the node itself (921-0 to 924-0 and 921-1 to 924-1). At the communication cycle i, the nodes 1 and 2 transmit fault-monitoring results concerning the nodes 1 and 2; the nodes 3 and 4 transmit fault-monitoring results concerning the nodes 3 and 4. At the communication cycle i+1, the nodes transmit the remaining data. Since the results include no data indicating “abnormality” and are normally received by the nodes, no malfunction is found in the fault identification (ID) for the fault-identification round k−1. The fault identification (ID) is divided into the communication cycles i and i+1 and generates a result at the communication cycle i+1 (931-1 to 934-1, which represent node numbers in charge). None of the nodes turns on the node fault flag (951-0 to 954-0 and 951-1 to 954-1). The fault-identification result exchange (EXD2) and the fault identification (ID2) for the fault-identification round k−2 are also performed. The error counter values are set to 2 for the majority malfunction of the node 3 and to 0 otherwise. The error counter value for each node indicates 2 corresponding to the majority malfunction of the node 3 and indicates 0 otherwise. No change is made from a communication cycle i−1 (941-0 to 944-0 and 941-1 to 944-1).

The fault monitoring (MON) is performed for the fault-identification round k in parallel with the fault-monitoring result exchange (EXD1) for the fault-identification round k−1. During the fault monitoring (MON), each node detects no fault at the communication cycle i (911-0 to 914-0). The node 3 is subject to a CPU fault at the end of the communication cycle i and causes a sequence number malfunction. At the communication cycle i+1, the nodes 1, 2, and 4 detect the fault of the node 3 (911-1 to 914-1).

At the communication cycles i+2 and i+3, the fault-monitoring result exchange (EXD1, 901-2 to 904-2 and 901-3 to 904-3) for the fault-identification round k is performed similarly to the fault-identification round k−1. Each node acquires the fault-monitoring results including the fault detection from the node 3 at the communication cycle i+1 (921-2 to 924-2 and 921-3 to 924-3). The fault identification (ID1) for the fault-identification round k is also performed similarly to the fault-identification round k−1. At the communication cycle i+3, the node 1 in charge of the node 3 identifies the majority malfunction of the node 3 (931-3 to 934-3). All the nodes detect no fault during the concurrently performed fault monitoring (MON) for the fault-identification round k+1 (911-2 to 914-2 and 911-3 to 914-3). While the fault-identification result exchange (EXD2) and the fault identification (ID2) for the fault-identification round k−1 are also concurrently performed, no change is made to the error counters (941-2 to 944-2 and 941-3 to 944-3) and the node fault flags (951-2 to 954-2 and 951-3 to 954-3).

At the communication cycles i+4 and i+5, the fault-identification result exchange (EXD2) and the fault identification (ID2) for the fault-identification round k are performed in parallel with the fault monitoring (MON) for the fault-identification round k+2 and the fault-monitoring result exchange (EXD1) for the fault-identification round k+1. The majority malfunction of the node 3 detected by the node 1 is transmitted to the other nodes (901-4). The nodes recognize the majority malfunction of the node 3 and increment the corresponding error counter value to 3 at the communication i+5 (941-5 to 944-5). Consequently, the nodes turn on the node fault flag corresponding to the majority malfunction of the node 3 (951-5 to 954-5).

As mentioned above, the CPU fault of the node 3 is identified by each node and the corresponding node fault flag notifies the application of the fault. The fault-identification process according to the inter-node monitoring in FIG. 6 can be performed in a pipelined fashion in synchronization with the communication cycle. The time-base process distribution reduces the load for the CPU processing and the quantity of the communication per communication cycle compared to a case without the time-base process distribution. The minority malfunction is processed in the same way as the above example, which describes the majority malfunction.

### Third Embodiment

In the above-mentioned examples, the periods (communication cycles) are constant for the fault-monitoring process (MON) and for the fault-monitoring result exchanges (EXD and EXD1) and the fault identifications (ID, ID1, and ID2) that are divided and performed. These periods can be changed while the system is in operation. In other words, it is also possible to use a variable cycle for performing the fault identification based on the mutual monitoring.

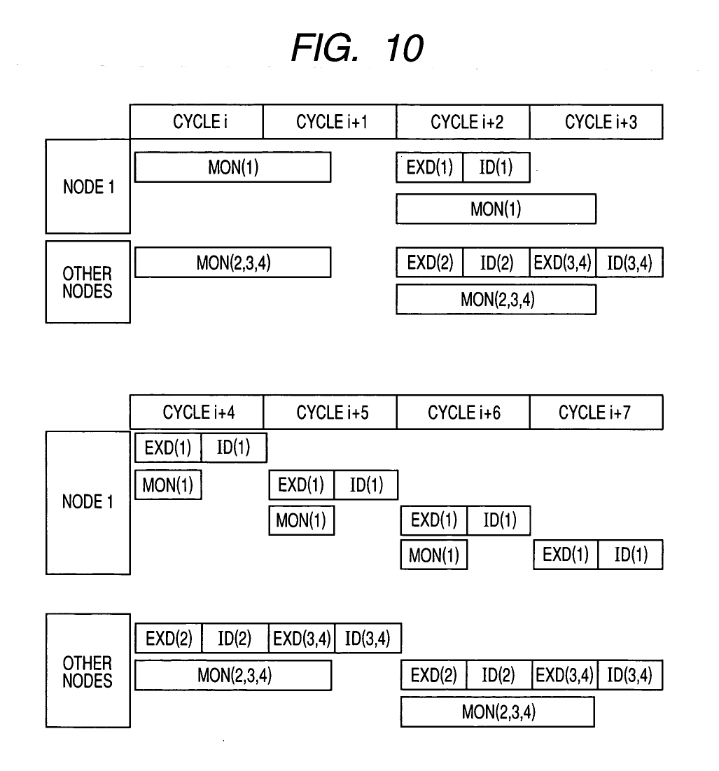

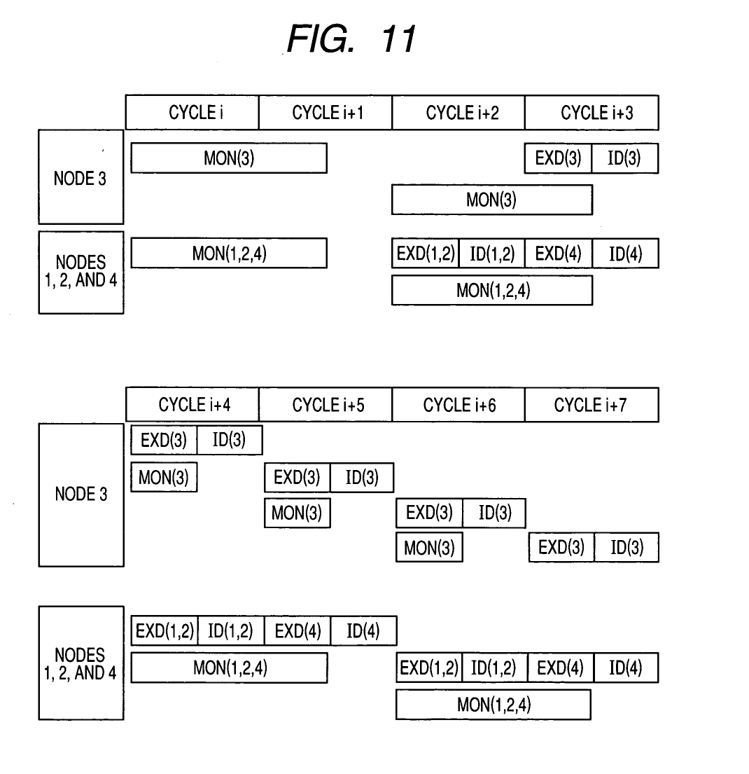

FIGS. 10 and 11 illustrate examples of changing cycles for performing the fault-monitoring process (MON), the fault-monitoring result exchange (EXD), and the fault-identification process (ID) while the system is in operation for the parallel processing of the fault-identification according to the mutual monitoring in FIG. 3.

One method of changing the cycle of the fault identification is, when a fault occurs in a node, to shorten the cycles of the processes associated with the fault identification for the node. The method is based on the principle that the node subject to a fault needs to perform the fault identification in a short cycle. The cycle may be changed when the error counter value becomes greater than or equal to a specified value. This is because the error counter has synchronization means and can synchronize a timing to change the cycle among the nodes.

FIG. 10 shows an example of changing the fault-identification cycle of the node 1. The communication cycles i to i+3 are the same as those shown in FIG. 3. In the example, however, the error counter value for the node 1 becomes greater than or equal to the specified value during the fault identification (ID) for the node 1 at the communication cycle i+2, causing the cycle of the fault identification for the node 1 to be shortened from the normal two cycles to one cycle. As a result, the period (communication cycle) of the fault monitoring (MON) for the node 1 is shortened at the communication cycle i+4 and later. The fault-monitoring result exchange (EXD) and the fault identification (ID) for the node 1 are also performed at one cycle next to the cycle of the fault monitoring (MON). In this case, the fault-monitoring result exchange (EXD) for the node 1 is also performed in parallel with the fault monitoring (MON) for all the nodes. Consequently, the fault identification (ID) for the node 1 is performed in a pipelined fashion at each cycle.

FIG. 11 shows an example of changing the fault-identification cycle of the node 3. The communication cycles i to i+3 are the same as those shown in FIG. 3. In the example, however, the error counter value for the node 3 becomes greater than or equal to the specified value during the fault identification (ID) for the node 3 at the communication cycle i+3, causing the cycle of the fault identification for the node 3 to be shortened from the normal two cycles to one cycle. As a result, the period (communication cycle) of the fault monitoring (MON) for the node 3 is shortened at the communication cycle i+4 and later. The fault-monitoring result exchange (EXD) and the fault identification (ID) for the node 3 are also performed at one cycle next to the cycle of the fault monitoring (MON). The fault-monitoring result exchange (EXD) and the fault identification (ID) corresponding to the fault monitoring (MON) for the node 3 at communication cycles i+2 and i+3 are performed at the communication cycle i+4 advanced from the scheduled communication cycle i+5. Instead, at the communication cycle i+5, the fault-monitoring result exchange (EXD) and the fault identification (ID) corresponding to the fault monitoring (MON) for the node 3 at the communication cycle i+4 are performed. Similarly, at a communication cycle i+6 and later, the fault-monitoring result exchange (EXD) and the fault identification (ID) corresponding to the fault monitoring (MON) at the communication cycle i+5 and subsequent cycles advanced by one cycle from those scheduled are performed, respectively. As for the node 3, the fault identification (ID) is performed at every cycle.

Even if the fault-monitoring result exchange (EXD) is performed for three cycles or longer, the processes of the fault-monitoring result exchange (EXD) and the fault identification (ID) are moved up and performed as shown in FIG. 11 when changing the cycle for the fault identification.

In FIGS. 10 and 11, even if the error counter value is not synchronized among the nodes due to a communication failure or the like and the cycle of the fault identification is not changed for some of the nodes, processes associated with the fault identification have little difference in terms of effectiveness before and after the change of the cycles. The reasons are as follows. The above-mentioned fault-identification method detects no malfunction in a node that is subject to no change in the cycle and does not transmit a fault-monitoring result at a shorter cycle than the usual one. Even when an error counter value for the node differs from that for another node, the error counter synchronization means synchronizes the error counter values within several communication cycles.

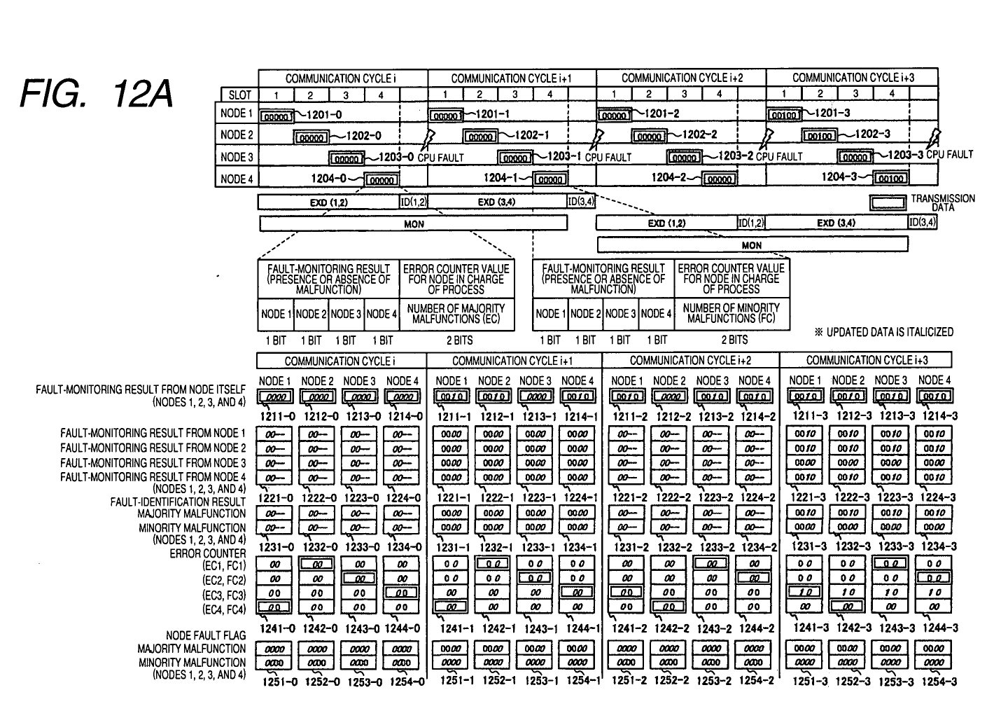

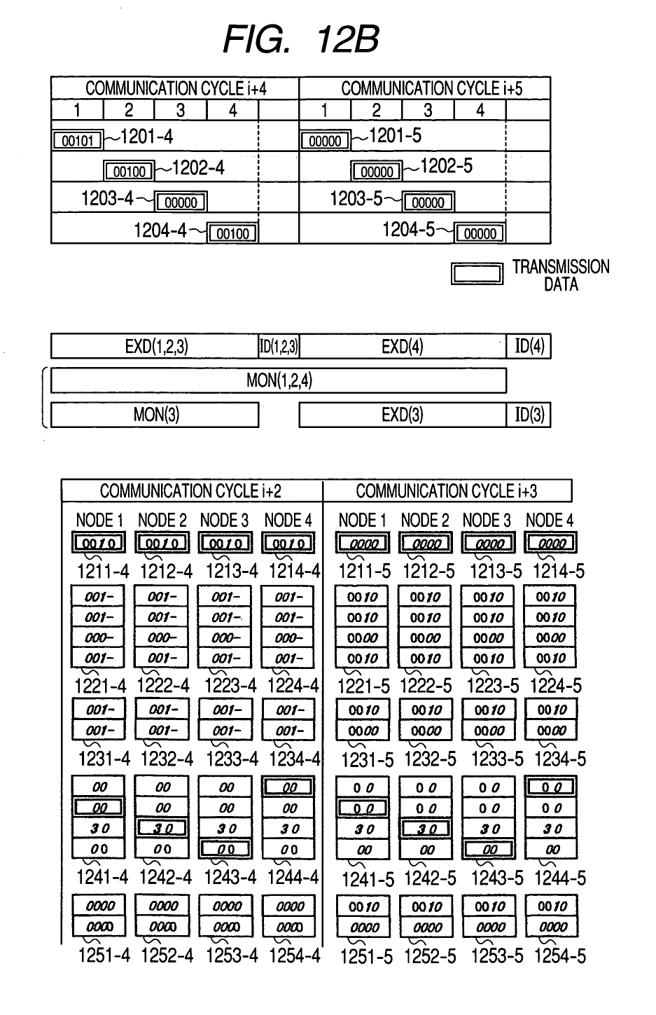

FIGS. 12A and 12B show operation examples of the fault-identification process according to the inter-node monitoring. The process flow is based on FIG. 2. The time-base process distribution and the process pipelining are compliant with FIG. 11. The conditions, such as the fault-monitoring items, are the same as those shown in FIG. 5. A difference is that the transmission data includes the bits of the fault-monitoring result for the nodes 1 to 4 at every cycle. Whether or not to use the fault-monitoring result depends on the cycle of the fault identification. The fault identification (ID) does not necessarily use the fault-monitoring result.

The communication cycles i to i+3 are almost same as those shown in FIG. 5. As a difference from FIG. 5, all nodes are assigned 0 as an initial error counter value concerning the majority malfunction of the node 3 (1241-0 to 1244-0, 1241-1 to 1244-1, and 1241-2 to 1244-2). Therefore, when the nodes identify the majority malfunction of the node 3 at the communication cycle i+3 (1231-3 to 1234-3), the corresponding error counter value is incremented to 1 (1241-3 to 1244-3). In addition, the node 3 causes a CPU malfunction at the communication cycles i+1 to i+3, causing a sequence number malfunction in the node 3 itself. Consequently, the nodes 1, 2, and 4 detect the fault of the node 3 using the fault monitoring (MON) at the communication cycles i+2 to i+4 (1211-2 to 1214-2, 1211-3 to 1214-3, and 1211-4 to 1214-4).

The error counter value concerning the majority malfunction of the node 3 is set to 1 at the communication cycle i+3. The nodes then change the fault-identification cycle for the node 3 from 2 to 1. A fault of the node 3 detected at the communication cycles i+2 and i+3 (1211-2 to 1214-2 and 1211-3 to 1214-3) is used for the fault-monitoring result exchange (EXD) at the communication cycle i+4 (an OR operation is carried out to regard the faults at the communication cycles i+2 and i+3 as one fault). A fault of the node 3 detected at the communication cycle i+4 (1211-4 to 1214-4) is used for the fault-monitoring result exchange (EXD) at the communication cycle i+5. Assuming that a fault-identification round corresponds to the communication cycles i and i+1 is the fault-identification round 1, the round 2 corresponds to the communication cycles i+2 and i+3; the round 3 corresponds to the communication cycle i+4. The corresponding fault identifications (ID) are performed at the communication cycles i+3 (1231-3 to 1234-3), i+4 (1231-4 to 1234-4), and i+5 (1231-5 to 1234-5), respectively. The error counter values for the nodes corresponding to majority malfunctions of the node 3 are incremented (1241-3 to 1244-3, 1241-4 to 1244-4, and 1241-5 to 1244-5). The counter value is set to 3 at the communication cycle i+5. The node fault flag corresponding to the majority malfunction of the node 3 is turned on (1245-1 to 1245-5).

As mentioned above, the CPU fault of the node 3 is identified by each node and the corresponding node fault flag notifies the application of the fault. The fault-identification process according to the inter-node monitoring in FIG. 2 can change the cycle of the fault identification while the system is in operation. The flow chart in FIG. 6 and the minority malfunction are processed in the same way as the above example, which describes the flow chart in FIG. 2 and the majority malfunction.

Control systems using the distributed system are applied to a wide range of industrial fields, such as vehicles, construction equipment, and factory automation (FA). The present invention can ensure high system reliability and improve availability based on backup control for the distributed control systems.

According to the present invention, the distributed systems can be controlled at low cost without additional special apparatus.

What is claimed is:

1. A distributed system comprising plural nodes being connected to each other via a network,
wherein each of the nodes comprises:
a fault-monitoring section for monitoring a fault in other nodes;
a transmission and reception section for transmitting and receiving data to detect the fault in other nodes via the network;
and
a fault-identification section for identifying which node has the fault based on the data, and
wherein the fault-monitoring section uses plural communication cycles as a monitoring period, the plural communication cycles being synchronized between the nodes.

2. The distributed system according to claim 1,
wherein the transmission and reception section includes a monitoring result from the fault-monitoring section in transmission and reception data and distributes transmission and reception of the data into a next monitoring period that is a next period of when the monitoring result is obtained.

3. The distributed system according to claim 1,
wherein the fault-identification section distributes fault identification into a next monitoring period that is a next period of when the monitoring result is obtained by the fault-monitoring section, the monitoring result being included in the data.

4. The distributed system according to claim 1,
wherein the fault-monitoring section, while the distributed system is in operation, changes the monitoring period for each node to be monitored.
